(19) United States
(12) Patent Application Publication
(10) Pub. No.: US 2007/0249381 A1
(43) Pub. Date: Oct. 25, 2007

(54) APPARATUS AND METHOD FOR CONVERSATIONAL-STYLE PUSH-TO-TALK

(75) Inventor: Jan Forslow, San Mateo, CA (US)

Correspondence Address: KALI LAW GROUP, P. C, P.O. BOX 60187, SUNNYVALE, CA, 94088-0187, US

(73) Assignee: SONIM TECHNOLOGIES, INC., San Mateo, CA (US)

(21) Appl. No.: 11/738,727

(22) Filed: Apr. 23, 2007

Related U.S. Application Data
(60) Provisional application No. 60/794,062, filed on Apr. 21, 2006.

(51) Int. Cl. H04B 7/00

(52) U.S. Cl. 455/517

(57) ABSTRACT

Methods for providing a conversational-style user experience in a simplex based session over a real-time communication network are presented, the method including: establishing the simplex based session between a first UE and a second UE by the real-time communication network; and while receiving a first media stream from the first UE, if the second UE has a first priority equal to the first UE, executing a first Reciprocal pre-emptive priority (Reciprocal-PP) interruption of the first UE by the second UE, wherein floor control is granted to the second UE such that the first UE is reconfigured to receive a second media stream from the second UE; and while receiving the second media stream from the second UE, if the first UE has a second priority equal to the second UE, executing a second Reciprocal-PP interruption of the second UE by the first UE.

### CROSS REFERENCE TO RELATED APPLICATIONS

The present invention is related to the following applications, all of which are incorporated herein by reference:

Commonly assigned application entitled “SYSTEMS AND METHODS FOR IMPLEMENTING LAZY-LOCK CONTROL IN REAL-TIME COMMUNICATION SERVICES,” filed on Apr. 5, 2007 date (Attorney Docket Number SONM-01800).

### PRIORITY CLAIM TO PROVISIONAL APPLICATION

A claim for priority is hereby made under the provisions of 35 U.S.C. § 119 for the present application based upon U.S. Provisional Application No. 60/794,062, filed on Apr. 21, 2006 which is incorporated herein by reference.

### BACKGROUND

Traditional Push-to-Talk (PTT) services have been deployed with strict floor control policies where right-to-speak is enforced through floor grant/floor taken procedures. Indicators such as various tones and beeps are typically utilized to indicate a variety of conditions including whether a user is permitted to request the floor and when a user is permitted to start and stop speaking. Furthermore in most use cases, a user is required to depress a PTT button both to gain control of the floor and to continue speaking, which in some circumstances may detract from a user's experience.

In a PTT system as described above, a user's experience may be quite limited by the available technology and, as such, may be very different from normal face-to-face conversations. For example, in a formal face-to-face meeting, human interactions may be governed, to some extent, by managerial authority. Managerial authority might dictate who is allowed to speak for how long and for what period of time. Mechanisms for interrupting a speaker may be explicit or implicit. In some instances, violation of those mechanisms may be seen as rude or impertinent. In contrast, typical PTT systems require strict floor control and may not typically be modified by a user. Thus, a “one size fits all” solution is imposed on users of a PTT system, which may not provide a desirable user experience.

PTT System Overview

Push-to-talk Over Cellular (PoC) is standardized by Open Mobile Alliance (OMA). This standard is discussed in greater detail in the following technical specifications which are herein incorporated by reference in their entirety:

“Push to talk over Cellular Requirements”, Candidate Version 1.0—29 Mar. 2005, Open Mobile Alliance™, OMA-RD-PoC-V1_{—}0-20050329-C;

“Push to talk over Cellular Architecture”, Candidate Version 1.0—27 Jan. 2006, Open Mobile Alliance™, OMA-AD_PoC-V1_{—}0-20060127-C;

“PoC XDM Specification”, Candidate Version 1.0—Jan. 20, 2006, Open Mobile Alliance™, OMA-TS-PoC-XDM-V1_{—}0-20060120-C;

“PoC Control Plane”, Candidate Version 1.0—27 Jan. 2006, Open Mobile Alliance™, OMA-TS_PoC-ControlPlane-V1_{—}0-20060127-C; and

“PoC User Plane”, Candidate Version 1.0—27 Jan. 2006, Open Mobile Alliance™, OMA-TS_PoC-UserPlane-V1_{—}0-20060127-C.

The OMA PoC Version 1 standard utilizes a Talk Burst Control Protocol (TBCP) for allocating the floor to a PoC session participant. TBCP is detailed in the OMA PoC User Plane specification. A high-level overview also exists in the OMA PoC Architecture document. The PoC server TBCP state machine manages the allocation of floor to PoC session participants. In the basic usage scenario, i.e. with no queuing of floor requests, a participant can only request the floor once the floor idle indication is received. The floor idle indication is given in the form of a tone and/or a visual display. If the participant attempts to take the floor prior to receiving a floor idle indication, then this floor request will be rejected with an error message, e.g. “other user speaking” and/or an associated floor deny tone. When requesting the floor after having received a floor idle indication, the participant will need to wait for a floor granted indication before being able to speak. This time delay is added into the standard in order to ensure that only one participant can be given the floor at any given time. However, from a usability perspective, this time delay is often seen as a nuisance as the participant must depress the PTT button while waiting and listening carefully for a right-to-speak tone/visual display from the phone before starting to speak.

FIG. 1 is an illustrative representation of a prior art PoC System architecture 100 in accordance with OMA version 1 specifications. An OMA PoC system architecture 100 includes User Equipment (UE) 102 and a set of network components. As illustrated, UE 102 contains the necessary pieces to interface the user acting as participant in a PoC session under the OMA version 1 specifications. UE 102 can either be a mobile terminal, a PC or any other device connected to the access network. Device Management (DM) client 104 inside UE 102 is used to bootstrap UE 102 with necessary configuration data from a DM server 116. An XML Document Management Client (XDMC) 110 is used to download and update by request any relevant contact lists stored in Shared XML Document Management Server (XDMS) 122. An Aggregation Proxy 124 may be configured to perform the authentication of any such requests. Similarly, the XDMC 110 is also configured to communicate via Aggregation Proxy 124 with PoC-specific XDMS (PoC XDMS) 126 for the purpose of managing group policies and authorization lists. UE 102 further includes Presence Source 106 and Presence Watcher 108. Presence Source 106 may be configured to publish a UE's availability status to other users. Presence Watcher 108 may be configured to retrieve availability status of others (e.g. other UEs and contacts). Both UE presence entities communicate with Presence Server 120 via a SIP/IP Core 118. In an OMA PoC system built on top of a GPRS radio network (Access Network 114), a SIP/IP Core is often a IP Multimedia Subsystem (IMS) as standardized by the 3rd Generation Partnership Project (3GPP).

A PoC client's main responsibilities are: session management, SIP registration, TBCP request-response management, media transmission, and media reception. Under existing standards, session management, SIP registration may be accomplished over POC-1 and POC-2 interfaces 132 and 136 respectively. Furthermore, TBCP request-response management, media transmission, and media may be accomplished over POC-3 interface 134. PoC server 128 is responsible for application level network functionality including PoC session establishment, termination, handling of TBCP messages and media switching between the participating clients.

Embodiments of the present invention relate specifically to POC-3 interface 34 transmissions occurring between a PoC client 112 and a PoC server 128. A POC-3 interface, in accordance with OMA standards, applies Talk Burst Control Protocol (TBCP) as a floor control protocol and sends media using the Real-Time Transfer Protocol (RTP). Floor control refers to permission for a UE to speak or otherwise send media. TBCP state machines are instantiated in both PoC clients and PoC servers after a successful SIP session establishment has occurred on POC-1 and POC-2 interfaces. In an OMA PoC system, when a PoC client sends a TBCP_Request message to a PoC server to ask for the permission to talk, the PoC server determines an appropriate response. That is, whether or not to grant permission based on floor availability. This response may be communicated back to the PoC client using appropriate messages (e.g. TBCP_Grant message or TBCP_Deny message). When a PoC server sends a TBCP_Grant message, permission to speak is granted to the requesting PoC client whereupon the requesting PoC client's media may be forwarded to other session participants. When a PoC server sends a TBCP_Deny message, permission to speak is denied to the requesting PoC client whereupon the requesting PoC client's media may be dropped by the PoC server.

There is also an option in OMA PoC version 1 to form a queue of floor requests in the PoC Server. The granting of floor will then happen directly to the next in line once the PoC Server receives a TBCP_Release message from first speaker. Related to queuing is also the option to associate a priority to a TBCP_Request message. A special type of priority is the pre-emptive priority. In an example where a participant with pre-emptive priority is requesting the floor and the current speaker has a lower priority, then a PoC Server will send a TBCP_Revoke message to the active speaker and allocate the floor directly to the participant with pre-emptive priority. It is worth noting that pre-emptive priority in the OMA PoC context needs to be negotiated at call setup time using SDP (Session Description Protocol) and cannot be applied if another participant with equal priority (i.e. pre-emptive priority) has the floor. Therefore, systems and methods for enabling conversational-style push-to-talk session are presented herein.

### SUMMARY

Methods are disclosed herein that provide for interruptions during a simplex-based system having multiple users thus approaching a conversational-style user experience. As such, methods for providing a conversational-style user experience in a simplex based session over a real-time communication network are presented, the method including: establishing the simplex based session between a first UE and a second UE by the real-time communication network; and while receiving a first media stream from the first UE, if the second UE has a first priority equal to the first UE, executing a first Reciprocal pre-emptive priority (Reciprocal-PP) interruption of the first UE by the second UE, wherein floor control is granted to the second UE such that the first UE is reconfigured to receive a second media stream from the second UE; and while receiving the second media stream from the second UE, if the first UE has a second priority equal to the second UE, executing a second Reciprocal-PP interruption of the second UE by the first UE, wherein floor control is granted to the first UE such that the second UE is reconfigured to receive a third media stream from the first UE. In some embodiments, executing the first Reciprocal-PP interruption includes: making a first pre-emptive user request for interrupting the first UE to the real-time communication network by the second UE; sending a first floor control revoke message to the first UE by the real-time communication network; sending a first floor control release message to the real-time communication network by the first UE; simultaneously sending a first floor control grant message to the second UE and a first floor taken message to the first UE by the real-time communication network; and sending the second media stream to the first UE over the real-time communication network by the second UE.

In some embodiments, executing the second Reciprocal-PP interruption includes: making a second pre-emptive user request for interrupting the second UE to the real-time communication network by the first UE; sending a second floor control revoke message to the second UE by the real-time communication network; sending a second floor control release message to the real-time communication network by the second UE; substantially simultaneously sending a second floor control grant message to the first UE and a second floor taken message to the second UE by the real-time communication network; and sending the third media stream to the second UE over the real-time communication network by the first UE. In some embodiments, if the first priority is lower than the second priority, denying the first Reciprocal-PP interruption of the first UE by the real-time communication network, and if the second priority is lower than the first priority, denying the second Reciprocal-PP interruption of the second UE by the real-time communication network. In some embodiments, the real-time communication network is a Push-to-Talk over Cellular (PoC) system and wherein the simplex based session is a Push-to-Talk (PTT) session. In some embodiments, the PoC system includes a PoC server for handling messages and media between the first UE and the second UE, and wherein the first UE and the second UE each include: a PoC client for communicating with the PoC server; and a user interface for providing user input to the PoC system and for providing PoC system output to a user. In some embodiments, the Reciprocal-PP interruptions include: a global assignment over the PoC system, an individual assignment for each PoC client, a group assignment for a group of pre-arranged groups of PoC clients, a 1:1 Ad Hoc assignment, and a group Ad Hoc assignment.

In some embodiments, the PoC server and the PoC client communicate over a PoC-3 interface. In some embodiments, messages and media are transmitted over an access network and an IP core. In some embodiments, the access network includes: a generic packet radio service (GPRS) network, an edge network, a universal mobile telecommunications systems (UMTS) network, a code division multiple access (CDMA) network, a worldwide interoperability for microwave access (WIMAX) network, a wireless fidelity (Wi-Fi) network, and a local area network (LAN). In some embodiments, the first media stream, the second media stream, and the third media stream include: audio data, text data, image data, and video data. In some embodiments, the first Reciprocal-PP interruption and the second Reciprocal-PP interruption are denied for a time interval, where the time interval is in the range of approximately 500 to 5000 milliseconds (ms). In some embodiments, the time interval is in the range of approximately 1000 to 4000 ms.

In other embodiments, methods for providing a conversational-style user experience in a simplex based session over a real-time communication network are presented including: establishing the simplex based session between a first UE and a second UE by the real-time communication network; and while receiving a first media stream from the first UE, if the second UE has a permission to pre-emptively interrupt, executing a first Reciprocal pre-emptive priority (Reciprocal-PP) interruption of the first UE by the second UE, wherein floor control is granted to the second UE such that the first UE is reconfigured to receive a second media stream from the second UE; and while receiving the second media stream from the second UE, if the first UE has the permission to pre-emptively interrupt, executing a second Reciprocal-PP interruption of the second UE by the first UE, wherein floor control is granted to the first UE such that the second UE is reconfigured to receive a third media stream from the first UE. In some embodiments, executing the first Reciprocal-PP interruption includes: making a first pre-emptive user request for interrupting the first UE to the real-time communication network by the second UE; sending a first floor control revoke message to the first UE by the real-time communication network; sending a first floor control release message to the real-time communication network by the first UE; simultaneously sending a first floor control grant message to the second UE and a first floor taken message to the first UE by the real-time communication network; and sending the second media stream to the first UE over the real-time communication network by the second UE.

In some embodiments, executing the second Reciprocal-PP interruption includes: making a second pre-emptive user request for interrupting the second UE to the real-time communication network by the first UE; sending a second floor control revoke message to the second UE by the real-time communication network; sending a second floor control release message to the real-time communication network by the second UE; simultaneously sending a second floor control grant message to the first UE and a second floor taken message to the second UE by the real-time communication network; and sending the third media stream to the second UE over the real-time communication network by the first UE. In some embodiments, if the second UE does not have the permission to pre-emptively interrupt the first UE, sending a first floor control deny message to the second UE by the real-time communication network, and wherein if the first UE does not have the permission to pre-emptively interrupt the second UE, sending a second floor control deny message to the first UE by the real-time communication network.

In other embodiments, methods for providing a conversational-style user experience in a PTT session over a real-time communication network, the real-time communication network incorporating a right-to-send procedure are presented including: establishing the PTT session between a first user equipment (UE) and a second UE by the real-time communication network where a lazy-lock implementation is enabled; while receiving a first media stream from the first UE, if the second UE has a first priority equal to the first UE, executing a Reciprocal pre-emptive priority (Reciprocal-PP) interruption of the first UE by the second UE utilizing the lazy-lock implementation wherein floor control is granted to the second UE such that the first UE is reconfigured to receive a second media stream from the second UE; and while receiving the second media stream from the second UE, if the first UE has a second priority equal to the second UE, executing the Reciprocal-PP interruption of the second UE by the first UE utilizing the lazy-lock implementation, where floor control is granted to the first UE such that the second UE is reconfigured to receive a third media stream from the first UE. In some embodiments, executing the first Reciprocal-PP interruption includes: making a first pre-emptive user request for interrupting the first UE to the real-time communication network by the second UE; sending the second media stream to the real-time communications network by the second UE before receiving a floor control grant message from the real-time communications network in accordance with the lazy-lock implementation; sending a first floor control revoke message to the first UE by the real-time communication network; sending a first floor control release message to the real-time communication network by the first UE; simultaneously sending a first floor control grant message to the second UE and a first floor taken message to the first UE by the real-time communication network; and sending the second media stream to the first UE by the real-time communication network.

In some embodiments, executing the second Reciprocal-PP interruption includes: making a second pre-emptive user request for interrupting the second UE to the real-time communication network by the first UE; sending the third media stream to the real-time communications network by the first UE before receiving a floor control grant message from the real-time communications network in accordance with the lazy-lock implementation; sending a second floor control revoke message to the second UE by the real-time communication network; sending a second floor control release message to the real-time communication network by the second UE; simultaneously sending a second floor control grant message to the first UE and a second floor taken message to the second UE by the real-time communication network; and sending the third media stream to the second UE by the real-time communication network.

In other embodiments, methods for providing a conversational-style user experience in a PTT session over a real-time communication network, the real-time communication network incorporating a right-to-send procedure are presented including: establishing the PTT session between a first user equipment (UE) and a second UE by the real-time communication network wherein a lazy-lock implementation is enabled; while receiving a first media stream from the first UE, if the second UE has a first priority equal to the first UE, executing a Reciprocal pre-emptive priority (Reciprocal-PP) interruption of the first UE by the second UE utilizing the lazy-lock implementation wherein floor control is granted to the second UE such that the first UE is reconfigured to receive a second media stream from the second UE; and while receiving the second media stream from the second UE, if the first UE has a second priority equal to the second UE, executing the Reciprocal-PP interruption of the second UE by the first UE utilizing the lazy-lock implementation, wherein floor control is granted to the first UE such that the second UE is reconfigured to receive a third media stream from the first UE. In some embodiments, executing the first Reciprocal-PP interruption includes: sending the second media stream to the real-time communications network by the second UE; determining whether to grant floor control to the second UE by a PoC server triggered by reception of the second media stream in accordance with the lazy-lock implementation; if floor control is granted, sending the second media stream to the first UE by the real-time communication network; and if floor control is denied, dropping the second media stream. In some embodiments, executing the second Reciprocal-PP interruption includes: sending the third media stream to the real-time communications network by the first UE; determining whether to grant floor control to the first UE by the PoC server triggered by reception of the third media stream in accordance with the lazy-lock implementation; if floor control is granted, sending the third media stream to the second UE by the real-time communication network; and if floor control is denied, dropping the third media stream.

### BRIEF DESCRIPTION OF THE DRAWINGS

The foregoing and other features, aspects, and advantages will become more apparent from the following detailed description when read in conjunction with the following drawings, wherein:

FIG. 1 is an illustrative representation of a prior art PoC System architecture 100 in accordance with OMA version 1 specifications;

FIG. 2 is an illustrative prior art dataflow for a OMA PoC version 1 mechanism for floor request/response handling and media sending when using pre-emptive priority level indicator in the floor control request;

FIG. 3 is an illustrative dataflow for Talk Burst allocation when authorizing reciprocal pre-emptive priority in PoC server utilizing a pre-emptive priority level indicator in the floor control request in the floor control request in accordance with embodiments of the present invention;

FIG. 4 is an illustrative dataflow for Talk Burst allocation when authorizing reciprocal pre-emptive priority in PoC server and not requiring pre-emptive priority level indicator in the floor control request in the floor control request in accordance with embodiments of the present invention;

FIG. 5 is an illustrative dataflow for Talk Burst allocation in case reciprocal pre-emptive priority is combined with Lazy-Lock Floor Control procedures in the floor control request in accordance with embodiments of the present invention;

FIG. 6 is an illustrative dataflow for Talk Burst allocation in case reciprocal pre-emptive priority is combined with Lazy-Lock Floor Control procedures and subsequent request from one participant is denied due to too short interval from last time spoken in the floor control request in accordance with embodiments of the present invention; and

FIG. 7 is an illustrative representation of a set of anticipated variants for pre-emptive priority configuration assignment options for a PoC System floor control request in accordance with embodiments of the present invention.

GLOSSARY

| | |
|---|---|
| DM—Device Management | OMA defined protocol for bootstrapping handsets with |
| | configuration data from a Over-the-Air (OTA) provisioning |
| | server. |
| GSM—Global System for | The second generation digital technology originally developed |
| Mobile communication | for Europe but which now has in excess of 71% of the world |
| | market. Initially developed for operation in the 900 MHz band |
| | and subsequently modified for the 850, 1800 and 1900 MHz |
| | bands. |
| GPRS—Generic Packet Radio | Packet switched service on GSM networks that provides an |
| Service | Internet Protocol bearer for applications such as PoC. |
| IMS Core—IP Multimedia | The SIP/IP Core that controls call sessions over IP networks in |
| Subsystem | cellular networks. |
| OMA—Open Mobile | Standardization organization focused on mobile application |
| Alliance ™ | specifications such as PoC. |
| PoC—Push-to-Talk-over- | Push to Talk standard from OMA using the IP bearer of |
| Cellular | cellular packet switched networks such as GPRS. |
| PTT—Push-to-Talk | Similar to conventional walkie-talkie communication - users |
| | send a voice message to one or more recipients from a mobile |
| | phone by pushing a key. |
| RTP—Real-time Transfer | An IETF protocol for real-time transmission of audio and |
| Protocol | video. Current IETF RFC is 3550. |
| | http://www.ietf.org/rfc/rfc3550.txt |
| SDP—Session Description | SDP is used for describing and negotiating media |
| Protocol | characteristics as part of setting up multimedia sessions using |
| | SIP. The basic IETF RFC is 2327. |
| | http://www.ietf.org/rfc/rfc2327.txt?number=2327 |
| Shared XDMS—Shared XML | An XCAP server that manages XML documents (e.g. Contact |
| Document Management | Lists) that are needed for the PoC service and which may be |
| Server | shared with other service enablers (e.g. Presence). |
| SIP—Session Initiation | A signaling protocol for Internet conferencing, telephony, |
| Protocol | presence, events notification, and instant messaging. The |
| | current IETF RFC is 3261. |
| | http://www.ietf.org/rfc/rfc3261.txt?number=3261 |
| TBCP—Talk Burst Control | A floor control protocol defined by OMA for Push-to-Talk |
| Protocol | over Cellular (PoC) using RTP control messages. |
| UE—User Equipment | A terminal (e.g. handset or PC) with the PoC client application |
| | installed. |
| XCAP—XML Configuration | XCAP allows a client to read, write, and modify application |
| Access Protocol | configuration data, stored in XML format on a server. XCAP |
| | maps XML document sub-trees and element attributes to |
| | HTTP URIs, so that these components can be directly accessed |
| | by HTTP. |
| XDMC—XML Document | An XCAP client that manages XML documents stored in the |
| Management Client | network (e.g. PoC-specific documents in the PoC XDMS, |
| | Contact Lists in the Shared XDMS, etc). |
| XDMS—XML Document | An XCAP server that manages XML documents (e.g. Contact |
| Management Server | Lists) that are utilized by various applications. Each |
| | application has its own designated XDMS (e.g. PoC XDMS) |
| | and can utilize the Shared XDMS. |

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. For example, reference is made to an Open Mobile Alliance™ (OMA) PTT-over-Cellular (PoC) system, while other types of Push-to-Talk (PTT) systems using any mobile or fixed access network can also benefit form the present invention. Likewise, reference is made to PTT sessions, while the present invention can be applied to other types of voice over IP (VoIP) conference calls where floor control policies are applied as well as any simplex based services. Furthermore, it may be appreciated that embodiments described herein are applicable over any number of access networks including: a generic packet radio service (GPRS) network, an edge network, a universal mobile telecommunications systems (UMTS) network, a code division multiple access (CDMA) network, a worldwide interoperability for microwave access (WIMAX) network, a wireless fidelity (Wi-Fi) network, and a local area network (LAN). Still further, embodiments described herein may be interoperable with Open Mobile Alliance (OMA) PoC version 1 and OMA PoC version 2 standards without limitation.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Aspects of the present invention provide methods for participants in a PTT session to pre-empt each other while talking. When using universally applicable reciprocal pre-emptive priority along with Lazy-Lock Floor Control and/or client buffering, a right-to-speak becomes nearly instantaneous and alleviates any need for any start indicator such as a start-to-speak beep.

In embodiments described herein, conversational-style PTT capability may be embodied utilizing the following main functions without limitation and without departing from the present invention:

Reciprocal pre-emptive priority capability for all participants involved in a PoC session;

Unlimited time to speak for any participant if so wishing and not being interrupted;

Immediate right to speak with no start-to-speak tone when combined with Lazy-Lock Floor Control and client buffering;

Global, group-specific and subscriber service-related configuration options for authorizing reciprocal pre-emptive priority with or without priority level requests in floor control procedures;

Floor revoke windows configured to allow an interrupted participant to gracefully end a sentence before hearing voice of other participant having same priority level; and

Floor deny window to allow a participant recently allocated the floor to finish first sentence before being interrupted by other participant having same priority level.

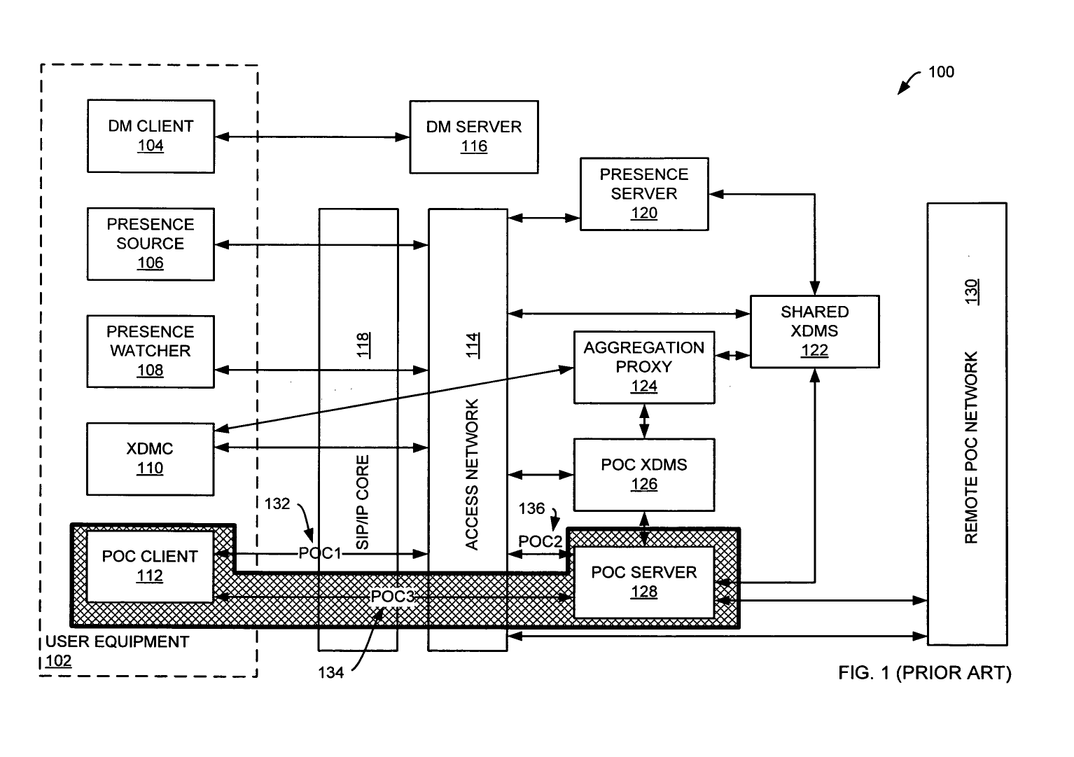

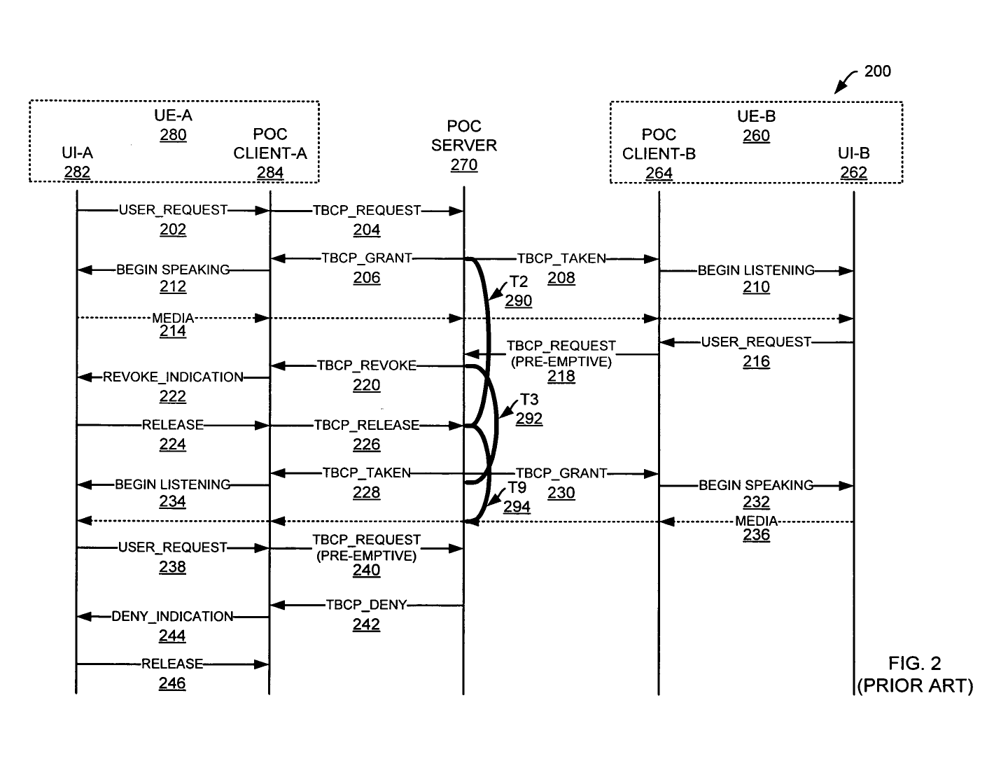

FIG. 2 is an illustrative prior art dataflow 200 for a OMA PoC version 1 mechanism for floor request/response handling and media sending when using pre-emptive priority level indicator in the floor control request. In particular, FIG. 2 depicts a Talk Burst Control Protocol (TBCP) request/response mechanism that runs across the POC-3 interface between PoC Client-A 284 and PoC Client-B 264 through PoC Server 270 when pre-emptive priority is applied as per the OMA PoC User Plane version 1 specification. A typical sequence begins with a user request 202 that may be effected when User-A presses a PTT button on user equipment (UE) 280 in order to request the floor. User-A utilizes an interface 282 on UE 280 to supply commands to PoC Client-A 284. In the illustrated example, User-A's request represents an initial request to the system where the floor is in an idle state. As such, PoC Client-A 284 sends a TBCP_Request message 204 to the PoC Server 270 without any priority level indication. It should be noted, however, that in this example, both PoC Client-A 284 and PoC Client-B 264 may have negotiated the capability to request pre-emptive priority earlier in the PoC session if so desired over the PoC-1 and PoC-2 interfaces (see FIG. 1) with the PoC Server 270 at session establishment using Session Initiation Protocol (SIP) and Session Description Protocol (SDP).

If the floor is idle when PoC Server 270 receives the TBCP_Request message 204, PoC server 270 may grant the floor request by sending a TBCP_Grant message 206 to PoC Client-A 284 and a TBCP_Taken message 208 to PoC Client-B 264 (and to any other participants of the current PoC session). User-A then receives a start indicator 212 such as a start-to-speak tone to indicate that the system is ready to receive media. User-B then receives a listen indicator 210 such as a start-to-listen tone to indicate the system is about to send media. Media 214 may then be sent from User-A to User-B via the PoC system (PoC Client-A 284, PoC Server 280, and PoC Client-B 264). It may be noted that when TBCP_Grant message is sent, T2 (stop talking) timer 290 is started. T2 timer 290 is a PoC Server timer configured to control how long a participant shall have permission to continuously speak. Under the OMA PoC User Plane specification, a T2 timer is set to a default of 30 seconds, which may indicate an intention to deny user-initiated interrupt capabilities in the standard. As will be seen, once a conversational-style PTT is implemented in embodiments disclosed herein, the need for T2 diminishes.

In the use case illustrated, User-B, however, begins to speak before User-A has released the floor and before T9 (retry after) timer 294 expires. User-B, therefore, initiates an interruption over User-A by making a user request 216 such as depressing the PTT button on the user-B's UE 260. The manner in which pre-emptive priority is determined in this use case is configured during session setup negotiation with a PoC Server 270. Pre-emption under the standard may be determined in the following manners: PoC Client-B 264 may be configured to always send a TBCP_Request message with pre-emptive priority level indicator; PoC Client-B 264 may be configured to send a TBCP_Request message only if the floor is busy; or PoC Client-B 264 may be configured to send a TBCP_Request message only under direct instruction to User-B through a user interface operation.

In this example, TBCP_Request 218 with pre-emptive priority level indicator will arrive at PoC Server 270. Because the current floor allocation is made without pre-emptive priority (where PoC Client-B 264 is authorized through the initial SIP session setup negotiation to use pre-emptive priority), PoC Server 270 may revoke PoC Client-A's 284 floor grant. Revocation is accomplished by sending a TBCP_Revoke message 220 to PoC Client-A 284 and starting a T3 (stop talking grace) timer 292 at PoC Server 270. PoC Client-A 284 then alerts User-A that it is time to stop speaking using a revoke indication 222 such as a stop-speaking tone. Having been made aware of revocation, User-A may then complete his sentence and release the PTT button 224. Releasing the PTT button triggers a TBCP_Release message 226 to be sent from PoC Client-A 284 to PoC Server 270. A last media packet indicator may be included in a TBCP_Release message. PoC Server 270 utilizes a last media packet indicator to determine when to change floor allocation. Floor allocation change will typically wait until the whole sentence (or last media packet) from User-A is routed through PoC Server 270 to PoC Client-B 264. Once the last packet is sent and before T3 (stop talking grace) timer 292 has expired, PoC Server 270 sends a TBCP_Grant message 230 to PoC Client-B 264 and a TBCP_Taken message 228 to PoC Client-A 284. PoC Client-B 264 indicates to User-B that the floor is granted 232 using a start-to-speak tone. In the same manner, PoC Client-A 284 indicates to User-A that the floor is taken 234 using a start-to-listen tone. Media 236 may then be sent from User-B to User-A through the PoC system.

At some point, User-A may decide to interrupt User-B. User-A, therefore, initiates an interruption over User-B by making a user request 238 such as depressing the PTT button on the user-A's UE 280. For this request, TBCP_Request message 240 is sent with pre-emptive priority. However, even if PoC Client-A 284 is authorized to use pre-emptive priority, PoC Server 270 will deny the floor to PoC Client-A 284 as per the OMA PoC User Plane specification subclause 6.4.5.1.1 which indicates:

“If the optional feature ‘priority’ has been negotiated at PoC Session initiation and if the priority level is pre-emptive and if the current PoC Client with permission to send a Talk Burst does not have the pre-emptive priority, the PoC Server SHALL send TBCPCP Talk Burst Granted message, including information about the stop talking timer, to the PoC Client.”

In other words, the OMA PoC User Plane specification does not allow a user with pre-emptive priority to interrupt another user which has taken the floor with pre-emptive priority. Therefore, in this example, PoC Server 270 sends a TBCP_Deny message 242 to PoC Client-A 284. PoC Client-A 284 indicates to User-A that the request is denied 244 using either a deny tone or visual display of other-user-speaking on User-A's interface 282 while media 236 is still flowing from User-B. User-A now understands that he cannot interrupt User-B until User-B releases the floor. Thus, although OMA PoC has many capabilities for priority handling of floor request, it does not provide adequate support for a Conversational-style PTT experience as disclosed herein.

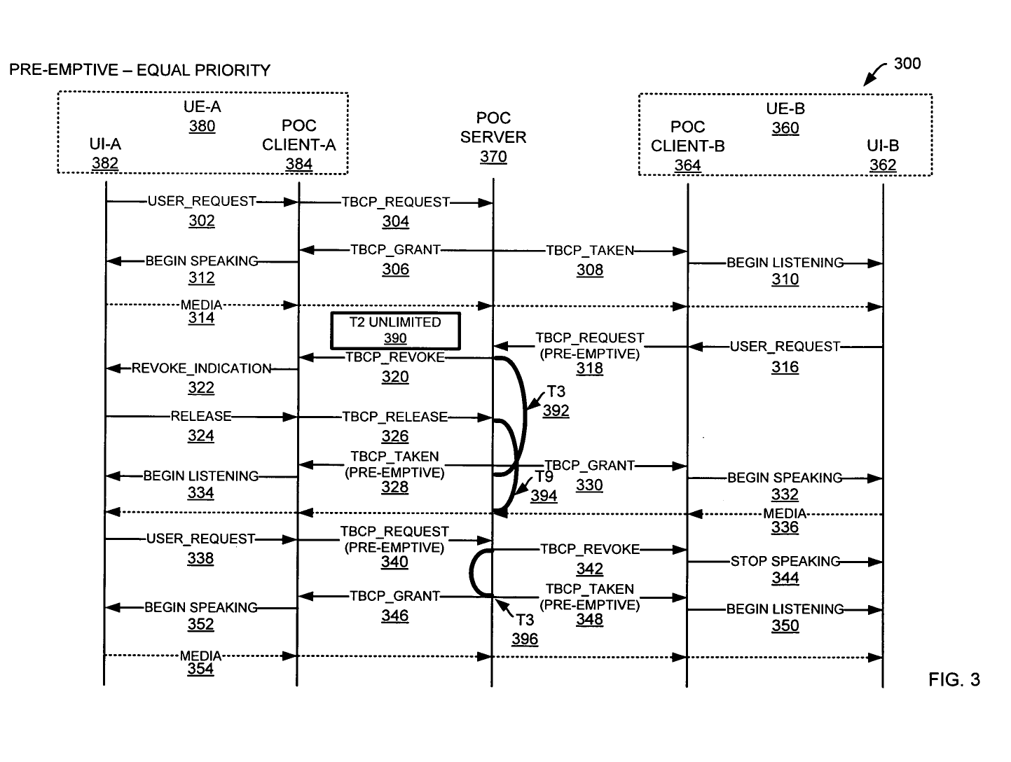

FIG. 3 is an illustrative dataflow 300 for Talk Burst allocation when authorizing reciprocal pre-emptive priority in PoC server utilizing a pre-emptive priority level indicator in the floor control request in the floor control request in accordance with embodiments of the present invention. In FIG. 3, PoC Client-A 384 and PoC Client-B 364 are required to negotiate pre-emptive priority capability at session setup using SDP as well as indicate in TBCP_Requests the priority level requested such as described above for FIG. 2. As above, the typical sequence begins with a user request 302 that may be effected when User-A presses a PTT button on user equipment (UE) 380 in order to request the floor. User-A utilizes an interface 382 on UE 380 to supply commands to PoC Client-A 384. As the user request represents an initial request to the system and the floor is idle, PoC Client-A 384 sends a TBCP_Request message 304 to the PoC Server 370 without any priority level indication.

If the floor is idle when PoC Server 370 receives TBCP_Request message 304, PoC server 370 may grant the floor request by sending a TBCP_Grant message 306 to PoC Client-A 384 and a TBCP_Taken message 308 to PoC Client-B 364 (and to any other participants of the current PoC session). User-A then receives a start indicator 312 such as a start-to-speak tone to indicate that the system is ready to receive media. As may be appreciated, embodiments described herein may include: audio data, text data, image data, and video data without limitation and without departing from the present invention. User-B then receives a listen indicator 310 such as a start-to-listen tone to indicate the system is about to send media. Media 314 may then be sent from User-A to User-B via the PoC system (PoC Client-A 384, PoC Server 380, and PoC Client-B 364). In previous FIG. 2, a T2 (stop talking) timer 290 was started when TBCP_Grant message 206 was sent. Here, however, the T2 (stop talking) timer has been set to unlimited length. The reason for setting the T2 (stop talking) timer is avoid having the PoC system regulate the length of time any participant can speak. Regulation will now be accomplished by the participants rather than by the PoC Server and the T2 (stop talking) timer. In addition, an option in the TBCP_Taken message has been added to indicate that pre-emptive priority was applied when allocating the floor. The added option allows for other non-speaking parties to know when to request pre-emptive priority in subsequently interrupting actions utilizing TBCP_Request messages in embodiments described herein.

At some point, User-B may elect to interrupt User-A. User-B, therefore, initiates an interruption over User-A by making a user request 316 such as depressing the PTT button on the user-B's UE 360. Again, the manner in which pre-emptive priority is determined in this use case is configured during session setup negotiation with a PoC Server 370. Pre-emption under the standard may be determined in the following manners: PoC Client-B 364 may be configured to always send a TBCP_Request message with pre-emptive priority level indicator; PoC Client-B 364 may be configured to send a TBCP_Request message only if the floor is busy; or PoC Client-B 364 may be configured to send a TBCP_Request message only under direct instruction to User-B through a user interface operation.

In this example, TBCP_Request 318 with pre-emptive priority level indicator will arrive at PoC Server 370. Because the current floor allocation is made without pre-emptive priority (where PoC Client-B 364 is authorized through the initial SIP session setup negotiation to use pre-emptive priority), PoC Server 370 may revoke PoC Client-A's 384 floor grant. Revocation is accomplished by sending a TBCP_Revoke message 320 to PoC Client-A 384 and starting a T3 (stop talking grace) timer 392 at PoC Server 370. PoC Client-A 384 then alerts User-A that it is time to stop speaking using a revoke indication 322 such as a stop-speaking tone. Having been made aware of revocation, User-A may then complete his sentence and release the PTT button 324. Releasing the PTT button triggers a TBCP_Release message 326 to be sent from PoC Client-A 384 to PoC Server 370. A last media packet indicator may be included in the TBCP_Release message. PoC Server 370 utilizes a last media packet indicator to determine when to change floor allocation. Floor allocation change will typically wait until the whole sentence (or last media packet) from User-A is routed through PoC Server 370 to PoC Client-B 364. Once the last packet is sent and before T3 (stop talking grace) timer 392 has expired, PoC Server 370 sends a TBCP_Grant message 330 to PoC Client-B 364 and a TBCP_Taken message 328 to PoC Client-A 384. PoC Client-B 364 indicates to User-B that the floor is granted 332 using a start-to-speak tone. In the same manner, PoC Client-A 384 indicates to User-A that the floor is taken 334 using a start-to-listen tone. Media 336 may then be sent from User-B to User-A through the PoC system.

At some point, User-A may decide to interrupt User-B. As noted above, in prior art solutions, User-A may not interrupt User-B. However, in embodiments described herein, User-A may make initiate a Reciprocal pre-emptive priority (Reciprocal-PP) interruption over User-B by making a user request 338 such as depressing the PTT button on the user-A's UE 380. PoC Client-A 384 sends a TBCP_Request message 340 with a pre-emptive priority level indication. Instead of rejecting this request due to an already existing floor allocation with pre-emptive priority to PoC Client-B 364 as described in prior art solutions, PoC Server 370 may now grant the floor to PoC Client-A 384 due to a novel configuration option in the PoC Server 370 called Reciprocal-PP, which may be enabled (ON) or disabled (OFF). In a Reciprocal-PP interruption schema, any participant having an equal priority level with another participant can pre-empt that participant. As such, PoC Server 370 issues a TBCP_Revoke message 342 to PoC Client-B 364 whereupon PoC Client-B 364 then alerts User-B that it is time to stop speaking using a revoke indication 344 such as a stop-speaking tone. PoC Server 370 also issues a TBCP_Grant message to PoC Client-A 384 and a TBCP_Taken message to PoC Client-B 364. PoC Client-B 364 indicates to User-B that the floor is taken 350 using a start-to-listen tone. In the same manner, PoC Client-A 384 indicates to User-A that the floor is taken 352 using a start-to-speak tone. Media 354 may then be sent from User-A to User-B through the PoC system.

In some examples, User-B may not wish to yield the floor. If User-B ignores a stop-speaking tone 344 associated with the TBCP_Revoke 342 as sent by the PoC Server 370, then no TBCP_Release message will be sent from PoC Client-B 364. Accordingly, another mechanism from the OMA PoC User Plane specification may instead server to limit's User-B's control of the floor, namely the backup function that T3 (stop talking grace) timer 396 expires. As noted above, T3 (stop talking grace) timer is used in OMA PoC to allow the speaking participant to finalize his sentence before his media is ignored or dropped by a PoC Server. In this example, T3 (stop talking grace) timer 396 expires before any TBCP_Release message has been sent by PoC Client-B. PoC Server 370 initiates a floor change when T3 (stop talking grace) timer 396 expires and initiates a floor change. That is, PoC server 370 sends a TBCP_Grant message 346 to PoC Client-A 384 and TBCP_Taken message 348 to PoC Client-B 364. PoC Client-B 364 will now be forced to indicate to User-B that the floor is taken 350 using a start-to-listen tone and to change UE-B 360 from recording mode to playout mode in order to handle incoming media from User-A. In all likelihood, User-B will then realize that there is no point in pressing the PTT button any longer and then release the PTT button.

Both OMA PoC approaches of using TBCP_Release or T3 timer expiry to trigger transition from pending revoke state to floor idle state in the PoC Server are applicable for Conversational-style PTT. Embodiments as described for FIG. 3 do not change the behavior of either as compared to OMA PoC, but it is worth noting that in Conversational-style PTT, TBCP_Release/T3 expiry on TBCP_Revoke will become the norm rather than a seldom used error case as on OMA PoC. It is also worth noting that the latter capability of T3 expiry is preferably brought down to a sub-second level in Conversational-style PTT in order to improve volley times at reciprocal pre-emption. This can be compared with standard OMA PoC, which states that T3 (stop talking grace) timer is by default 3 seconds and shall be between 1 to 10 times the T8 (TBCP_Revoke resend) timer, which in turn is by default 1 second. This would create volley times of around 5 sec (3 sec for T3; 1 sec for TBCP_Request+TBCP_Granted; and 1 sec for sending media). Such volley times of are only acceptable if used for error cases as in OMA PoC, but not in Conversational-style PTT as it might create confusion and irritation for all participants involved in the session.

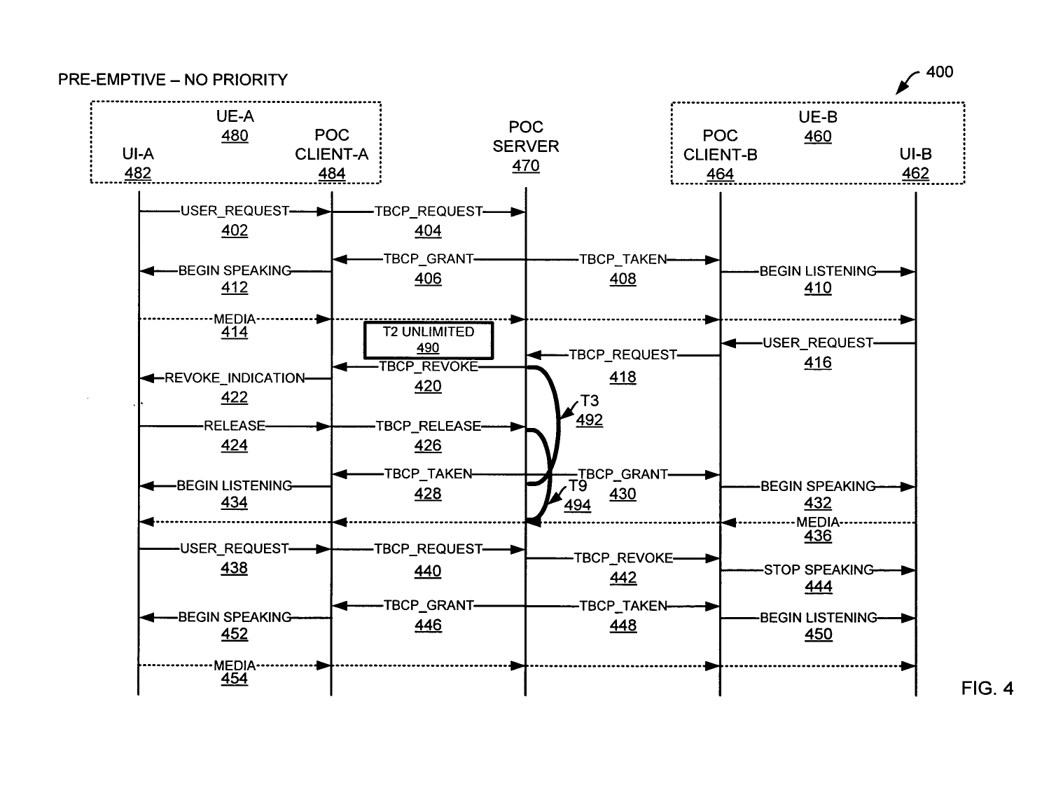

FIG. 4 is an illustrative dataflow 400 for Talk Burst allocation when authorizing reciprocal pre-emptive priority in a PoC server and not requiring pre-emptive priority level indicator in the floor control request in accordance with embodiments of the present invention. Embodiments illustrated by FIG. 4 introduce important changes as compared with FIG. 3 and, as such, introduces additional deviations from a standard OMA PoC. For example, in a standard OMA PoC any participant that wants to use the priority level capability is required to first negotiate this using SDP in the SIP session setup signaling. The participant may then request a priority level in the TBCP_Request. Priority levels may be lower to or equal to what was negotiated using SDP. This schema may appear reasonable in a PoC system like OMA PoC where a participant only can pre-empt if the currently talking participant has a made a TBCP_Request with lower priority level. In this manner, the standard allows for pre-emption as often as possible. Thus, participants should not request or implicitly be allocated their highest negotiated/subscribed priority level all the time. In conversational-style PTT, however, such a schema may be impractical as conversational-style PTT strives to allow reciprocal pre-emptive priority among all participants without regard to priority. As such, the need for signaling priority levels in SIP and TBCP messages may be viewed as redundant or unnecessary complex.

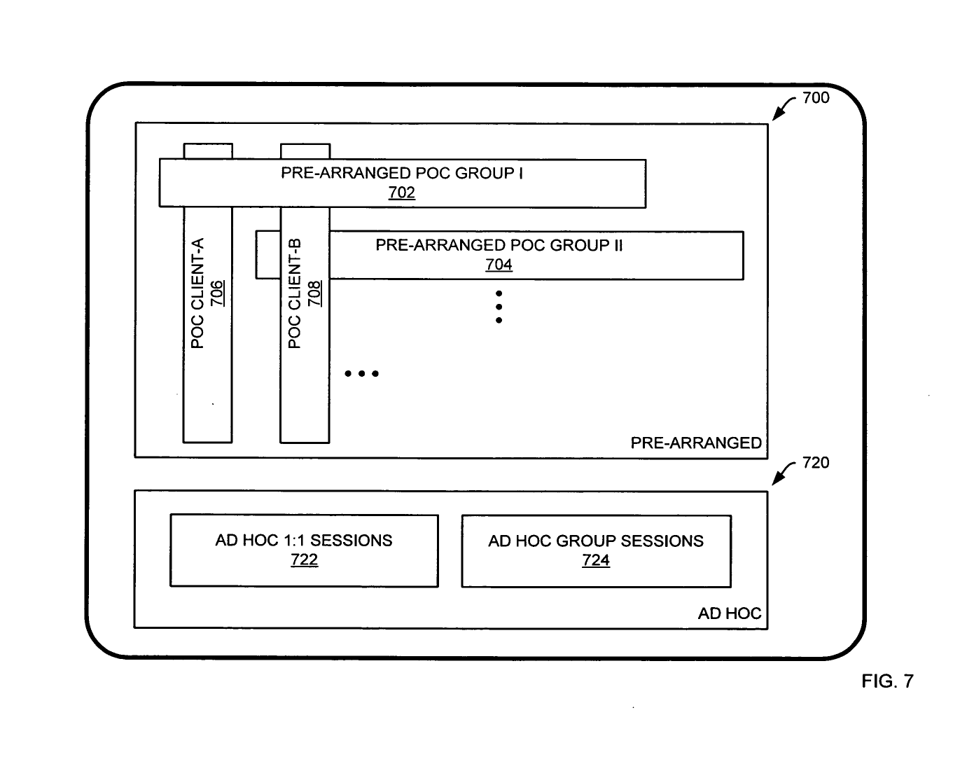

FIG. 4, therefore, illustrates a data flow when PoC Server 470 is enabled with a global or group session-specific configuration option for Reciprocal-PP (Reciprocal-PP=ON). When Reciprocal-PP is set to ON, then PoC Server 470 will allow pre-emption for TBCP_Requests arriving without any pre-emptive priority level indicator. That is, all participants have permission to pre-emptively interrupt another participant. In one embodiment, all priorities are configured to be equal. In some embodiments, all priorities are set to the maximum allowable. It may be appreciated that setting all priorities to equal has the effect of nullifying any priority requirements. The PoC Server may still apply local policies (e.g. subscription checks) to determine whether a participant requesting the floor has the right to perform pre-emption or not. Applying local policies may also be used to differentiate between participants in the same PoC session. Policy configurations are discussed in further detail below for FIG. 7. FIG. 4 illustrates a non-signaled, pre-emptive priority procedure first in the case of PoC Client-B's TBCP_Request message 418 and then for PoC Client-A's second TBCP_Request message 440. PoC Server 470 has, in this example, no local policy that differentiates between PoC Client-A 484 and PoC Client-B 464. Therefore, with Reciprocal-PP set to On, all interrupting TBCP_Request messages are granted.

As above, the typical sequence begins with a user request 402 that may be effected when User-A presses a PTT button on user equipment (UE) 480 in order to request the floor. User-A utilizes an interface 482 on UE 480 to supply commands to PoC Client-A 484. As the user request represents an initial request to the system and the floor is idle, PoC Client-A 484 sends a TBCP_Request message 404 to the PoC Server 470 without any priority level indication. If the floor is idle when PoC Server 470 receives the TBCP_Request message 404, PoC server 470 may grant the floor request by sending a TBCP_Grant message 406 to PoC Client-A 484 and a TBCP_Taken message 408 to PoC Client-B 464 (and to any other participants of the current PoC session). User-A then receives a start indicator 412 such as a start-to-speak tone to indicate that the system is ready to receive media. As may be appreciated, embodiments described herein may include: audio data, text data, image data, and video data without limitation and without departing from the present invention. User-B then receives a listen indicator 410 such as a start-to-listen tone to indicate the system is about to send media. Media 414 may then be sent from User-A to User-B via the PoC system (PoC Client-A 484, PoC Server 480, and PoC Client-B 464).

At some point, User-B may elect to interrupt User-A. User-B, therefore, initiates a Reciprocal-PP interruption over User-A by making a user request 416 such as depressing the PTT button on the user-B's UE 460. Unlike embodiments disclosed for FIG. 3, no priority is required or ascertained by the system. Rather, all TBCP_Requests are granted. In this example, TBCP_Request message 418 will arrive at PoC Server 470. Because the current floor allocation is made without regard to priority, PoC Server 470 may revoke PoC Client-A's 484 floor grant. Revocation is accomplished by sending a TBCP_Revoke message 420 to PoC Client-A 484 and starting a T3 (stop talking grace) timer 492 at PoC Server 470. PoC Client-A 484 then alerts User-A that it is time to stop speaking using a revoke indication 422 such as a stop-speaking tone. Having been made aware of revocation, User-A may then complete his sentence and release the PTT button 424. Releasing the PTT button triggers a TBCP_Release message 426 to be sent from PoC Client-A 484 to PoC Server 470. A last media packet indicator may be included in the TBCP_Release message. PoC Server 470 utilizes a last media packet indicator to determine when to change floor allocation. Floor allocation change will typically wait until the whole sentence (or last media packet) from User-A is routed through PoC Server 470 to PoC Client-B 464. Once the last packet is sent and before T3 (stop talking grace) timer 492 has expired, PoC Server 470 sends a TBCP_Grant message 430 to PoC Client-B 464 and a TBCP_Taken message 428 to PoC Client-A 484. PoC Client-B 464 indicates to User-B that the floor is granted 432 using a start-to-speak tone. In the same manner, PoC Client-A 484 indicates to User-A that the floor is taken 434 using a start-to-listen tone. Media 436 may then be sent from User-B to User-A through the PoC system.

At some point, User-A may decide to interrupt User-B. As noted above, in prior art solutions, User-A may not interrupt User-B. However, in embodiments described herein, User-A may make initiate a Reciprocal-PP interruption over User-B by making a user request 438 such as depressing the PTT button on the user-A's UE 480. PoC Client-A 484 sends a TBCP_Request message 440. Instead of rejecting this request due to an already existing floor allocation with pre-emptive priority to PoC Client-B 464 as described in prior art solutions, PoC Server 470 may now grant the floor to PoC Client-A 484 due to Reciprocal-PP, which may be enabled (ON) or disabled (OFF). As noted above, in a Reciprocal-PP schema, any participant having an equal priority level with another participant can pre-empt that participant. As such, PoC Server 470 issues a TBCP_Revoke message 442 to PoC Client-B 464 whereupon PoC Client-B 464 then alerts User-B that it is time to stop speaking using a revoke indication 444 such as a stop-speaking tone. PoC Server 470 also issues a TBCP_Grant message 446 to PoC Client-A 484 and a TBCP_Taken message 448 to PoC Client-B 464. PoC Client-B 464 indicates to User-B that the floor is taken 450 using a start-to-listen tone. In the same manner, PoC Client-A 484 indicates to User-A that the floor is taken 452 using a start-to-speak tone. Media 454 may then be sent from User-A to User-B through the PoC system.

As may be appreciated, the change to OMA PoC procedures disclosed above may reduce the complexity of the PoC system significantly without sacrificing benefits of Conversational-style PTT. The proposed changes provide an additional benefit of removing one of the limitations in OMA PoC User Plane specification, which states that an implicit floor grant at SIP signaling session setup (normally given to the initiator of the PoC session), cannot be marked with a priority level and, as such, would be considered more vulnerable to interruption than when pre-emption is merely based on local policy evaluation in the PoC Server.

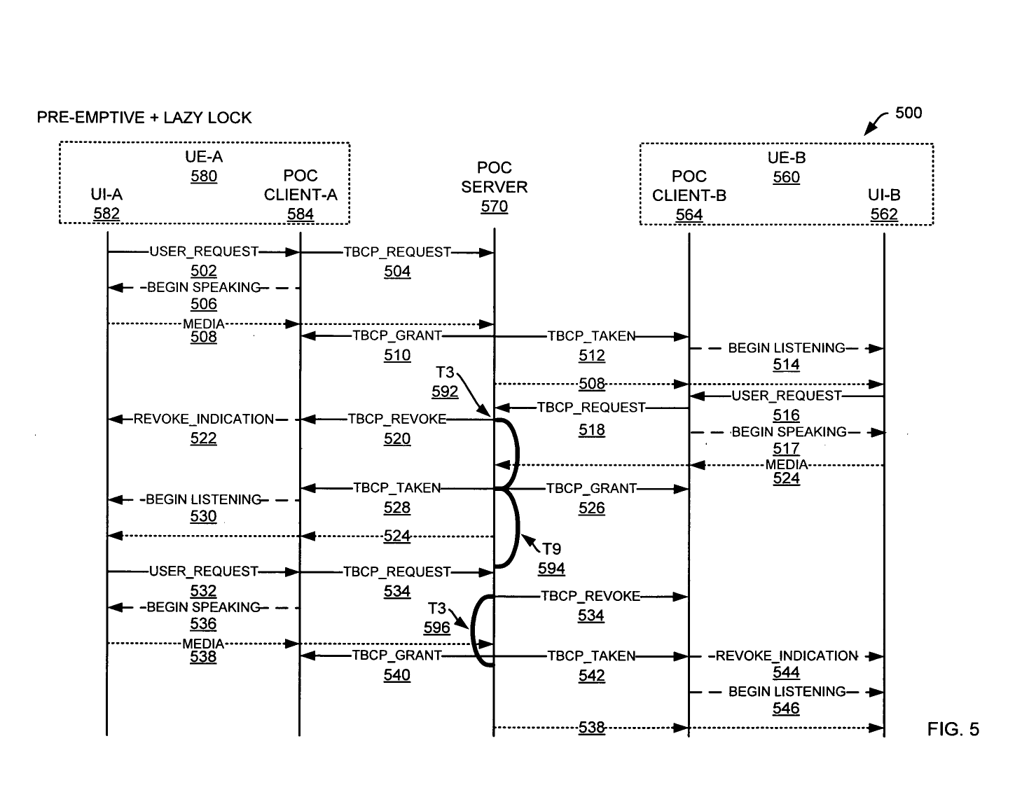

FIG. 5 is an illustrative dataflow 500 for Talk Burst allocation in case Reciprocal-PP is combined with Lazy-Lock Floor Control procedures in the floor control request in accordance with embodiments of the present invention. Lazy-Lock has been described in more detailed in the related patent application Ser. No. 11/696,866 entitled, “Systems and Methods for implementing Lazy-Lock Control in Real-time Communications Service,” which is incorporated herein by reference. In short, Lazy-Lock Floor Control procedure attempts to shorten the delay from an initial PTT button press on a sending side until media is played out on a receiving side. Lazy-Lock Floor Control Procedure is achieved by opportunistically sending a user's media directly after the user sends a TBCP_Request message. In a standard OMA PoC system, media can only be sent when the floor is in idle state. However, when combining Lazy-Lock Floor Control procedures with Conversational-style PTT, gaining floor control is now also possible when the floor is taken by another participant. As such, the introduction of Conversational-style PTT has increased the usability of Lazy-Lock Floor Control.

In the embodiment illustrated in FIG. 5, initial TBCP_Request from PoC Client-A is done in idle state and as such pure Lazy-Lock Floor Control applies. The sequence begins with a user request 502 that may be effected when User-A presses a PTT button on user equipment (UE) 580 in order to request the floor. User-A utilizes an interface 582 on UE 580 to supply commands to PoC Client-A 584. As the user request represents an initial request to the system and the floor is idle, PoC Client-A 584 sends a TBCP_Request message 504 to the PoC Server 570. User-A then receives a start indicator 506 such as a start-to-speak tone to indicate that the system is ready to receive media. As may be appreciated, embodiments described herein may include: audio data, text data, image data, and video data without limitation and without departing from the present invention. It may be noted that start indicator 506 is now represented using a dashed line. The dashed line is meant to indicate that start indicator 506 is optional. One reason for this is because media 508, under Lazy-Lock procedure, is sent immediately after TBCP_Request message 504 is sent to PoC Server 570. That is, there is no wait time for User-A to begin speaking after depressing the PTT button. Removal of start indicator 506 has several advantages. First, start indicator 506 as embodied in a start-to-speak tone, requires approximately 500 milliseconds (ms) to play out, which may delay delivery time of media to a participant. This delay may be further exacerbated if the UE platform on which the PoC Client resides does not have audio system capability for both recording and playout. In that example, switching between recording and playout may add an additional 200-800 ms. Additionally, user experience studies of PoC has shown that many users consider the quantity and quality of beeps too numerous and difficult to understand.

If the floor is idle when PoC Server 570 receives TBCP_Request message 504, PoC server 570 may grant the floor request by sending a TBCP_Grant message 510 to PoC Client-A 584 and a TBCP_Taken message 512 to PoC Client-B 564 (and to any other participants of the current PoC session). User-B then receives a listen indicator 514 such as a start-to-listen tone to indicate the system is about to send media. Buffered media 508 may then be sent from User-A to User-B via the PoC system (PoC Client-A 584, PoC Server 570, and PoC Client-B 564). In some embodiments, listen indicator 514 may be suppressed.

At some point, User-B may elect to interrupt User-A. User-B, therefore, initiates a Reciprocal-PP interruption over User-A by making a user request 516 such as depressing the PTT button on the user-B's UE 560. Prior to the introduction of Conversational-style PTT such a request would have been immediately suppressed and rejected by the PoC Client-B 564. With Conversational-style PTT however, TBCP_Request message 518 is sent to the PoC Server 570 by PoC Client-B 564 along with associated media 524. As Reciprocal-PP is enabled in the PoC Server 570 (Reciprocal-PP=ON), PoC Server 570 begins the procedure to switch the floor allocation from PoC Client-A 584 to PoC Client-B 564 by sending a TBCP_Revoke message 520 to PoC Client-A 584. As before, it may be noted that when TBCP_Revoke message 520 is sent, both User-A and User-B may be speaking at the same time. In order to avoid significant loss of speech for either side, embodiments may reduce T3 (stop talking grace) timer 592 to near zero.

Additionally, in some embodiments speak indicator 517 and listen indicator 530 may be suppressed. In other, non-OMA PoC embodiments, TBCP_Revoke messages may be suppressed. However, in order to keep the state machines intact in the OMA PoC example a TBCP_Revoke message 520 may be sent immediately before a TBCP_Taken message 528 from PoC Server 570 to PoC Client-A 584 without significant penalty. PoC server 570 may then grant the floor request by sending a TBCP_Grant message 526 to PoC Client-B 564 and a TBCP_Taken message 528 to PoC Client-BA 584 (and to any other participants of the current PoC session). User-A then receives a listen indicator 530 such as a start-to-listen tone to indicate the system is about to send media. Buffered media 524 may then be sent from User-B to User-A via the PoC system (PoC Client-A 584, PoC Server 570, and PoC Client-B 564). As noted above, in some embodiments, listen indicator 530 may be suppressed.

At some point, User-A may elect to interrupt User-B. User-A, therefore, initiates a Reciprocal-PP interruption over User-B by making a user request 532 such as depressing the PTT button on the User-A's UE 580. Prior to the introduction of Conversational-style PTT such a request would have been immediately suppressed and rejected by the PoC Client-A 584. With Conversational-style PTT however, TBCP_Request message 534 is sent to the PoC Server 570 by PoC Client-A 584 along with associated media 538. As Reciprocal-PP is enabled in the PoC Server 570 (Reciprocal-PP=ON), PoC Server 570 begins the procedure to switch the floor allocation from PoC Client-B 564 to PoC Client-A 584 by sending a TBCP_Revoke message 5537 to PoC Client-B 564. A speak indicator 536 such as a start-to-speak tone may be sent by PoC Client-A 684 to indicate that the system is ready to receive media. It may be noted that when TBCP_Revoke message 537 is sent, both User-B and User-A may speaking at the same time. In order to avoid significant loss of speech for either side, embodiments may reduce T3 (stop talking grace) timer 596 to near zero.

Additionally, in some embodiments speak indicator 536 and listen indicator 546 may be suppressed. In other, non-OMA PoC embodiments, TBCP_Revoke messages may be suppressed. However, in order to keep the state machines intact in the OMA PoC example a TBCP_Revoke message 537 may be sent immediately before a TBCP_Taken message 542 from PoC Server 570 to PoC Client-B 564 without significant penalty. PoC server 570 may then grant the floor request by sending a TBCP_Grant message 540 to PoC Client-A 584 and TBCP_Taken message 542 to PoC Client-BA 584 (and to any other participants of the current PoC session). User-B then receives a listen indicator 546 such as a start-to-listen tone to indicate the system is about to send media. Buffered media 538 may then be sent from User-A to User-B via the PoC system (PoC Client-B 564, PoC Server 570, and PoC Client-A 584). As noted above, in some embodiments, listen indicator 546 may be suppressed.

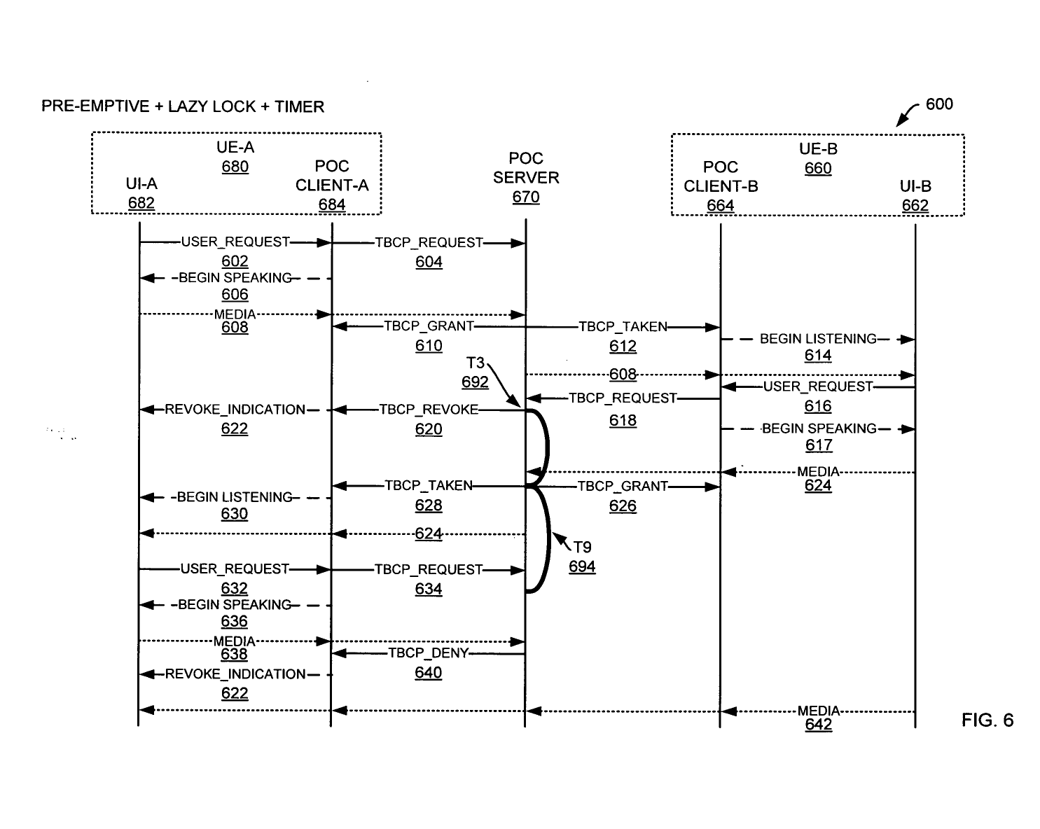

FIG. 6 is an illustrative dataflow 600 for Talk Burst allocation in case Reciprocal-PP is combined with Lazy-Lock Floor Control procedures and subsequent request from one participant is denied due to too short interval from last time spoken in the floor control request in accordance with embodiments of the present invention. The sequence begins with a user request 602 that may be effected when User-A presses a PTT button on user equipment (UE) 680 in order to request the floor. User-A utilizes an interface 682 on UE 680 to supply commands to PoC Client-A 684. As the user request represents an initial request to the system and the floor is idle, PoC Client-A 684 sends a TBCP_Request message 604 to the PoC Server 670. User-A then receives a start indicator 606 such as a start-to-speak tone to indicate that the system is ready to receive. As may be appreciated, embodiments described herein may include: audio data, text data, image data, and video data without limitation and without departing from the present invention. It may be noted that start indicator 606 is now represented using a dashed line. The dashed line is meant to indicate that start indicator 606 is optional. One reason for this is because media 608, under Lazy-Lock procedure, is sent immediately after TBCP_Request message 604 is sent to PoC Server 670. That is, there is no wait time for User-A to begin speaking after depressing the PTT button. Removal of start indicator 606 has several advantages. First, start indicator 606 as embodied in a start-to-speak tone, requires approximately 500 ms to play out, which may delay delivery time of media to a participant. This delay may be further exacerbated if the UE platform on which the PoC Client resides does not have audio system capability for both recording and playout. In that example, switching between recording and playout may add an additional 200-800 ms. Additionally, user experience studies of PoC has shown that many users consider the quantity and quality of beeps too numerous and difficult to understand.

If the floor is idle when PoC Server 670 receives TBCP_Request message 604, PoC server 670 may grant the floor request by sending a TBCP_Grant message 610 to PoC Client-A 684 and a TBCP_Taken message 612 to PoC Client-B 664 (and to any other participants of the current PoC session). User-B then receives a listen indicator 614 such as a start-to-listen tone to indicate the system is about to send media. Buffered media 608 may then be sent from User-A to User-B via the PoC system (PoC Client-A 684, PoC Server 670, and PoC Client-B 664). In some embodiments, listen indicator 614 may be suppressed.

At some point, User-B may elect to interrupt User-A. User-B, therefore, initiates a Reciprocal-PP interruption over User-A by making a user request 616 such as depressing the PTT button on the user-B's UE 660. Prior to the introduction of Conversational-style PTT such a request would have been immediately suppressed and rejected by the PoC Client-B 664. With Conversational-style PTT however, TBCP_Request message 618 is sent to the PoC Server 670 by PoC Client-B 664 along with associated media 624. As Reciprocal-PP is enabled in the PoC Server 670 (Reciprocal-PP=ON), PoC Server 670 begins the procedure to switch the floor allocation from PoC Client-A 684 to PoC Client-B 664 by sending a TBCP_Revoke message 620 to PoC Client-A 684. It may be noted that when TBCP_Revoke message 620 is sent, both User-A and User-B may be speaking at the same time. In order to avoid significant loss of speech for either side, embodiments may reduce T3 (stop talking grace) timer 692 to near zero.

Additionally, in some embodiments speak indicator 617 and listen indicator 630 may be suppressed. In other, non-OMA PoC embodiments, TBCP_Revoke messages may be suppressed. However, in order to keep the state machines intact in the OMA PoC example a TBCP_Revoke message 620 may be sent immediately before a TBCP_Taken message 628 from PoC Server 670 to PoC Client-A 684 without significant penalty. PoC server 670 may then grant the floor request by sending a TBCP_Grant message 626 to PoC Client-B 664 and TBCP_Taken message 628 to PoC Client-BA 684 (and to any other participants of the current PoC session). User-A then receives a listen indicator 630 such as a start-to-listen tone to indicate the system is about to send media. Buffered media 624 may then be sent from User-B to User-A via the PoC system (PoC Client-A 684, PoC Server 670, and PoC Client-B 664). As noted above, in some embodiments, listen indicator 630 may be suppressed.

At some point, User-A may elect to interrupt User-B. User-A, therefore, initiates a Reciprocal-PP interruption over User-B by making a user request 632 such as depressing the PTT button on the User-A's UE 680. Prior to the introduction of Conversational-style PTT such a request would have been immediately suppressed and rejected by the PoC Client-A 684. With Conversational-style PTT however, TBCP_Request message 634 is sent to the PoC Server 670 by PoC Client-A 684 along with associated media 638. A speak indicator 636 such as a start-to-speak tone may be sent by PoC Client-A 684 to indicate that the system is ready to receive media. However, in this embodiment, PoC Client-A 684 is sending TBCP_Request message 634 before T9 (retry after) timer 694 has expired. Thus, PoC Server 670 will detect this condition and reject User-A's floor request by sending a TBCP_Deny message 640 back to PoC Client-A 684. In OMA PoC, the T9 (retry after) timer is used to penalize a participant that has been revoked due to talking too long. In OMA PoC this is a severe condition. As such, T9 (retry after) timers are typically set to a default 5 seconds with an allowed range of 5-30 seconds. In Conversational-style PTT, revoking a participant is more of a norm rather than an exception, as TBCP_Revoke is sent anytime another participant request to interrupt the current speaker. As such the T9 (retry after) timer is not utilized to penalize a participant that speaks too long, but instead is used to give some leeway (time window) for a floor switch that recently occurred from PoC Client-A 684 to PoC Client-B 664 to take affect and stabilize (avoid raise conditions). As such, the T9 (retry after) timer may be selected to a value corresponding with the time it takes for the TBCP_Taken messages and TBCP_Grant message to traverse the access network. In some embodiments, the T9 (retry after) timer may be set to a range of approximately 500-1000 ms. In other embodiments, the T9 (retry after) timer may be set to a range of approximately 4000-5000 ms in order to ensure that PoC Client-B gets to state his case before PoC Client-A interrupts again.

It may be appreciated that in some embodiments that further utilize Lazy-Lock procedures, TBCP messages may be suppressed altogether such that a PoC server negotiates floor control automatically upon receiving media streams. Thus, in one embodiment, a first user may initiate a Reciprocal-PP interruption by simply pressing a PTT button and beginning to speak. A PoC server, in this example, would receive and buffer media sent from the first user; negotiate permission to interrupt the session; grant and revoke floor control appropriately; and subsequently send or drop the buffered media to a second user. The second user may, likewise, initiate a Reciprocal-PP interruption in the same manner—all without utilizing TBCP message where reception of media triggers control negotiations. Examples of Lazy-Lock procedures utilizing media as a trigger event are described in related application entitled “SYSTEMS AND METHODS FOR IMPLEMENTING LAZY-LOCK CONTROL IN REAL-TIME COMMUNICATION SERVICES,” which incorporated herein by reference.

FIG. 7 is an illustrative representation of a set of anticipated variants for pre-emptive priority configuration assignment options for a PoC System floor control request in accordance with embodiments of the present invention. Regardless of at what assignments are set in pre-emptive priority, various capabilities may be required: to set pre-emptive priority to OFF (i.e. always reject requests if floor is not in idle); to set pre-emptive priority to ON as per OMA PoC spec (i.e. only possible to pre-empt in case currently speaking participant has lower priority); and to set pre-emptive priority to ON for Conversational-style PTT mode (i.e. anyone with same priority or absent of priority can take the floor from currently speaking participant) as described in embodiments herein.

One configuration option is to set options as a system-global configuration option for the complete PoC Server. Settings would then apply to all subscribers (PoC Client-A, PoC Client-B, etc.) and all PoC services (Pre-arranged PoC Group I, Pre-arranged PoC Group II, etc., as well as Ad hoc 1:1 and Group Session). At another level of differentiation, setting options may be achieved by differentiation based on type of PoC service. For example, in OMA PoC, there are two types of PoC Services called Pre-arranged Groups 700 and Ad hoc Sessions 720. Pre-arranged Groups are groups which have been created in advance within the PoC Server through the creation of PoC Group documents as per the OMA PoC XDM specification. Pre-arranged groups may consist of any number of groups, 702-704 and any number of subscribers such as PoC Clients 706-708 without departing from the present invention. The PoC Group documents specify who are the list-members and what actions each list-member can do, e.g. allow-initiate-conference, allow-anonymity, etc. Pre-emptive priority is anticipated to become another possible action in the PoC XDM schema to be assigned to all or a subset of list-members.

In the case of Ad hoc PoC Sessions, there are no similar pre-defined schema that governs who will be able to participate and what actions they can perform. As such only a generic pre-emptive configuration option can be applied for these services in a similar fashion as for the PoC Server as a whole. Note though that there are two distinct types of Ad hoc PoC Sessions (1:1 sessions 772 and group sessions 724). As such it is possible to distinguish these two with separate configuration options for each. Finally, one can set pre-emptive priority as a subscription capability on an individual user level (i.e. separate for PoC Client-A and PoC Client-B). One challenge in allowing users to set the pre-emptive priority on all these levels (PoC Server, PoC Session and PoC Subscriber) is knowing which one takes precedence in a case of mismatch. The most common solution is to have the more specific configuration setting take precedence. This would mean that a setting at the PoC Subscriber level would dominate any setting at PoC Session or PoC Server level. An anticipated exception to this rule would be to have the Pre-arranged PoC Sessions not influenced and over-powered by any PoC Subscriber setting as often the Pre-arranged Groups actually are created, controlled and hosted by one PoC Subscriber.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. It is therefore intended that the following appended claims be interpreted as including all such alterations, permutations, and equivalents as fall within the true spirit and scope of the present invention.

What is claimed is:

1. A method for providing a conversational-style user experience in a simplex based session over a real-time communication network, the method comprising:
establishing the simplex based session between a first UE and a second UE by the real-time communication network; and
while receiving a first media stream from the first UE, if the second UE has a first priority equal to the first UE, executing a first Reciprocal pre-emptive priority (Reciprocal-PP) interruption of the first UE by the second UE, wherein floor control is granted to the second UE such that the first UE is reconfigured to receive a second media stream from the second UE; and
while receiving the second media stream from the second UE, if the first UE has a second priority equal to the second UE, executing a second Reciprocal-PP interruption of the second UE by the first UE, wherein floor control is granted to the first UE such that the second UE is reconfigured to receive a third media stream from the first UE.

2. The method of claim 1 wherein the executing the first Reciprocal-PP interruption comprises:
making a first pre-emptive user request for interrupting the first UE to the real-time communication network by the second UE;
sending a first floor control revoke message to the first UE by the real-time communication network;
sending a first floor control release message to the real-time communication network by the first UE;
substantially simultaneously sending a first floor control grant message to the second UE and a first floor taken message to the first UE by the real-time communication network; and
sending the second media stream to the first UE over the real-time communication network by the second UE.

3. The method of claim 2 wherein the executing the second Reciprocal-PP interruption comprises:
making a second pre-emptive user request for interrupting the second UE to the real-time communication network by the first UE;
sending a second floor control revoke message to the second UE by the real-time communication network;
sending a second floor control release message to the real-time communication network by the second UE;
substantially simultaneously sending a second floor control grant message to the first UE and a second floor taken message to the second UE by the real-time communication network; and
sending the third media stream to the second UE over the real-time communication network by the first UE.

4. The method of claim 1 wherein if the first priority is lower than the second priority, denying the first Reciprocal-PP interruption of the first UE by the real-time communication network, and wherein if the second priority is lower than the first priority, denying the second Reciprocal-PP interruption of the second UE by the real-time communication network.

5. The method of claim 3 wherein the real-time communication network is a Push-to-Talk over Cellular (PoC) system and wherein the simplex based session is a Push-to-Talk (PTT) session.

6. The method of claim 5 wherein the PoC system includes a PoC server for handling messages and media between the first UE and the second UE, and wherein the first UE and the second UE each include:
a PoC client for communicating with the PoC server; and
a user interface for providing user input to the PoC system and for providing PoC system output to a user.

7. The method of claim 6 wherein the Reciprocal-PP interruptions are configured based on an assignment selected from the group consisting of: a global assignment over the PoC system, an individual assignment for each PoC client, a group assignment for a group of pre-arranged groups of PoC clients, a 1:1 Ad Hoc assignment, and a group Ad Hoc assignment.

8. The method of claim 6 wherein the PoC server and the PoC client communicate over a PoC-3 interface.

9. The method of claim 8 wherein the messages and media are transmitted over an access network and an IP core.

10. The method of claim 9 wherein the access network is selected from the group consisting of: a generic packet radio service (GPRS) network, an edge network, a universal mobile telecommunications systems (UMTS) network, a code division multiple access (CDMA) network, a worldwide interoperability for microwave access (WIMAX) network, a wireless fidelity (Wi-Fi) network, and a local area network (LAN).

11. The method of claim 1 wherein the first media stream, the second media stream, and the third media stream are selected from the group consisting of: audio data, text data, image data, and video data.

12. The method of claim 1 wherein the simplex based service is a voice-over-IP (VoIP) session.

13. The method of claim 1 wherein the Reciprocal-PP interruption is interoperable with a standard selected from the group consisting of: Open Mobile Alliance (OMA) PoC version 1 and OMA PoC version 2.

14. The method of claim 1 wherein the first Reciprocal-PP interruption and the second Reciprocal-PP interruption are denied for a time interval, wherein the time interval is in the range of approximately 500 to 5000 milliseconds (ms).

15. The method of claim 14 wherein the time interval is in the range of approximately 1000 to 4000 ms.

16. A method for providing a conversational-style user experience in a simplex based session over a real-time communication network, the method comprising:
establishing the simplex based session between a first UE and a second UE by the real-time communication network; and
while receiving a first media stream from the first UE, if the second UE has a permission to pre-emptively interrupt, executing a first Reciprocal pre-emptive priority (Reciprocal-PP) interruption of the first UE by the second UE, wherein floor control is granted to the second UE such that the first UE is reconfigured to receive a second media stream from the second UE; and
while receiving the second media stream from the second UE, if the first UE has the permission to pre-emptively interrupt, executing a second Reciprocal-PP interruption of the second UE by the first UE, wherein floor control is granted to the first UE such that the second UE is reconfigured to receive a third media stream from the first UE.

17. The method of claim 16 wherein the executing the first Reciprocal-PP interruption comprises:
making a first pre-emptive user request for interrupting the first UE to the real-time communication network by the second UE;
sending a first floor control revoke message to the first UE by the real-time communication network;
sending a first floor control release message to the real-time communication network by the first UE;
substantially simultaneously sending a first floor control grant message to the second UE and a first floor taken message to the first UE by the real-time communication network; and
sending the second media stream to the first UE over the real-time communication network by the second UE.

18. The method of claim 17 wherein the executing the second Reciprocal-PP interruption comprises:
making a second pre-emptive user request for interrupting the second UE to the real-time communication network by the first UE;
sending a second floor control revoke message to the second UE by the real-time communication network;
sending a second floor control release message to the real-time communication network by the second UE;
substantially simultaneously sending a second floor control grant message to the first UE and a second floor taken message to the second UE by the real-time communication network; and
sending the third media stream to the second UE over the real-time communication network by the first UE.

19. The method of claim 16 wherein,
if the second UE does not have the permission to pre-emptively interrupt the first UE, sending a first floor control deny message to the second UE by the real-time communication network, and wherein if the first UE does not have the permission to pre-emptively interrupt the second UE, sending a second floor control deny message to the first UE by the real-time communication network.

20. The method of claim 16 wherein the real-time communication network is a Push-to-Talk over Cellular (PoC) system and wherein the simplex based session is a Push-to-Talk (PTT) session.

21. The method of claim 20 wherein the PoC system includes a PoC server for handling messages and media between the first UE and the second UE.

22. The method of claim 21 wherein the first UE and the second UE each include:
a PoC client for communicating with the PoC server; and
a user interface for providing user input to the PoC system and for providing PoC system output to a user.

23. The method of claim 22 wherein the Reciprocal-PP interruptions are configured based on an assignment selected from the group consisting of: a global assignment over the PoC system, an individual assignment for each PoC client, a group assignment for a group of pre-arranged groups of PoC clients, a 1:1 Ad Hoc assignment, and a group Ad Hoc assignment.

24. The method of claim 22 wherein the PoC server and the PoC client communicate over a PoC-3 interface.

25. The method of claim 24 wherein the messages and media are transmitted over an access network and an IP core.

26. The method of claim 25 wherein the access network is selected from the group consisting of: a generic packet radio service (GPRS) network, an edge network, a universal mobile telecommunications systems (UMTS) network, a code division multiple access (CDMA) network, a worldwide interoperability for microwave access (WIMAX) network, a wireless fidelity (Wi-Fi) network, and a local area network (LAN).

27. The method of claim 16 wherein the first media stream, the second media stream, and the third media stream are selected from the group consisting of: audio data, text data, image data, and video data.

28. The method of claim 16 wherein the simplex based service is a voice-over-IP (VoIP) session.

29. The method of claim 16 wherein the first Reciprocal-PP interruption and the second Reciprocal-PP interruption are denied for a time interval, wherein the time interval is in the range of approximately 500 to 5000 milliseconds (ms).

30. The method of claim 29 wherein the time interval is in the range of approximately 1000 to 4000 ms.

31. A method for providing a conversational-style user experience in a push-to-talk (PTT) session over a real-time communication network, the real-time communication network incorporating a right-to-send procedure, the method comprising:
establishing the PTT session between a first user equipment (UE) and a second UE by the real-time communication network wherein a lazy-lock implementation is enabled;
while receiving a first media stream from the first UE, if the second UE has a first priority equal to the first UE, executing a Reciprocal pre-emptive priority (Reciprocal-PP) interruption of the first UE by the second UE utilizing the lazy-lock implementation wherein floor control is granted to the second UE such that the first UE is reconfigured to receive a second media stream from the second UE; and
while receiving the second media stream from the second UE, if the first UE has a second priority equal to the second UE, executing the Reciprocal-PP interruption of the second UE by the first UE utilizing the lazy-lock implementation, wherein floor control is granted to the first UE such that the second UE is reconfigured to receive a third media stream from the first UE.

32. The method of claim 31 wherein the executing the first Reciprocal-PP interruption comprises:
making a first pre-emptive user request for interrupting the first UE to the real-time communication network by the second UE;
sending the second media stream to the real-time communications network by the second UE before receiving a floor control grant message from the real-time communications network in accordance with the lazy-lock implementation;
sending a first floor control revoke message to the first UE by the real-time communication network;
sending a first floor control release message to the real-time communication network by the first UE;
substantially simultaneously sending a first floor control grant message to the second UE and a first floor taken message to the first UE by the real-time communication network; and
sending the second media stream to the first UE by the real-time communication network.

33. The method of claim 32 wherein the executing the second Reciprocal-PP interruption comprises:
making a second pre-emptive user request for interrupting the second UE to the real-time communication network by the first UE;
sending the third media stream to the real-time communications network by the first UE before receiving a floor control grant message from the real-time communications network in accordance with the lazy-lock implementation;
sending a second floor control revoke message to the second UE by the real-time communication network;
sending a second floor control release message to the real-time communication network by the second UE;
substantially simultaneously sending a second floor control grant message to the first UE and a second floor taken message to the second UE by the real-time communication network; and
sending the third media stream to the second UE by the real-time communication network.

34. The method of claim 31 wherein if the first priority is lower than the second priority, denying the first Reciprocal-PP interruption of the first UE by the real-time communication network, and wherein if the second priority is lower than the first priority, denying the second Reciprocal-PP interruption of the second UE by the real-time communication network.

35. The method of claim 32 wherein the first Reciprocal-PP interruption and the second Reciprocal-PP interruption require a permission.

36. The method of claim 32 wherein the first Reciprocal-PP interruption and the second Reciprocal-PP interruption are denied for a time interval, wherein the time interval is in the range of approximately 500 to 5000 milliseconds (ms).

37. The method of claim 36 wherein the time interval is in the range of approximately 1000 to 4000 ms.

38. The method of claim 33 wherein the real-time communication network is a Push-to-Talk over Cellular (PoC) system and wherein the simplex based session is a Push-to-Talk (PTT) session.

39. The method of claim 38 wherein the PoC system includes a PoC server for handling messages and media between the first UE and the second UE, and wherein the first UE and the second UE each include:
a PoC client for communicating with the PoC server; and
a user interface for providing user input to the PoC system and for providing PoC system output to a user.

40. The method of claim 39 wherein the Reciprocal-PP interruptions are configured based on an assignment selected from the group consisting of: a global assignment over the PoC system, an individual assignment for each PoC client, a group assignment for a group of pre-arranged groups of PoC clients, a 1:1 Ad Hoc assignment, and a group Ad Hoc assignment.

41. The method of claim 39 wherein the PoC server and the PoC client communicate over a PoC-3 interface.

42. The method of claim 41 wherein the messages and media are transmitted over an access network and an IP core.

43. The method of claim 42 wherein the access network is selected from the group consisting of: a generic packet radio service (GPRS) network, an edge network, a universal mobile telecommunications systems (UMTS) network, a code division multiple access (CDMA) network, a worldwide interoperability for microwave access (WIMAX) network, a wireless fidelity (Wi-Fi) network, and a local area network (LAN).

44. The method of claim 31 wherein the first media stream, the second media stream, and the third media stream are selected from the group consisting of: audio data, text data, image data, and video data.

45. The method of claim 31 wherein the simplex based service is a voice-over-IP (VoIP) session.

46. A method for providing a conversational-style user experience in a push-to-talk (PTT) session over a real-time communication network, the real-time communication network incorporating a right-to-send procedure, the method comprising:
establishing the PTT session between a first user equipment (UE) and a second UE by the real-time communication network wherein a lazy-lock implementation is enabled;
while receiving a first media stream from the first UE, if the second UE has a first priority equal to the first UE, executing a Reciprocal pre-emptive priority (Reciprocal-PP) interruption of the first UE by the second UE utilizing the lazy-lock implementation wherein floor control is granted to the second UE such that the first UE is reconfigured to receive a second media stream from the second UE; and
while receiving the second media stream from the second UE, if the first UE has a second priority equal to the second UE, executing the Reciprocal-PP interruption of the second UE by the first UE utilizing the lazy-lock implementation, wherein floor control is granted to the first UE such that the second UE is reconfigured to receive a third media stream from the first UE.

47. The method of claim 46 wherein the executing the first Reciprocal-PP interruption comprises:
sending the second media stream to the real-time communications network by the second UE;
determining whether to grant floor control to the second UE by a PoC server triggered by reception of the second media stream in accordance with the lazy-lock implementation;
if floor control is granted, sending the second media stream to the first UE by the real-time communication network; and
if floor control is denied, dropping the second media stream.

48. The method of claim 47 wherein the executing the second Reciprocal-PP interruption comprises:
sending the third media stream to the real-time communications network by the first UE;
determining whether to grant floor control to the first UE by the PoC server triggered by reception of the third media stream in accordance with the lazy-lock implementation;
if floor control is granted, sending the third media stream to the second UE by the real-time communication network; and
if floor control is denied, dropping the third media stream.

49. The method of claim 46 wherein if the first priority is lower than the second priority, denying the first Reciprocal-PP interruption of the first UE by the real-time communication network, and wherein if the second priority is lower than the first priority, denying the second Reciprocal-PP interruption of the second UE by the real-time communication network.

50. The method of claim 47 wherein the first Reciprocal-PP interruption and the second Reciprocal-PP interruption require a permission.

51. The method of claim 47 wherein the first Reciprocal-PP interruption and the second Reciprocal-PP interruption are denied for a time interval, wherein the time interval is in the range of approximately 500 to 5000 milliseconds (ms).

52. The method of claim 51 wherein the time interval is in the range of approximately 1000 to 4000 ms.

53. The method of claim 48 wherein the real-time communication network is a Push-to-Talk over Cellular (PoC) system and wherein the simplex based session is a Push-to-Talk (PTT) session.

54. The method of claim 53 wherein the PoC system includes a PoC server for handling messages and media between the first UE and the second UE, and wherein the first UE and the second UE each include:
a PoC client for communicating with the PoC server; and
a user interface for providing user input to the PoC system and for providing PoC system output to a user.

55. The method of claim 54 wherein the Reciprocal-PP interruptions are configured based on an assignment selected from the group consisting of: a global assignment over the PoC system, an individual assignment for each PoC client, a group assignment for a group of pre-arranged groups of PoC clients, a 1:1 Ad Hoc assignment, and a group Ad Hoc assignment.

56. The method of claim 54 wherein the PoC server and the PoC client communicate over a PoC-3 interface.

57. The method of claim 56 wherein the messages and media are transmitted over an access network and an IP core.

58. The method of claim 57 wherein the access network is selected from the group consisting of: a generic packet radio service (GPRS) network, an edge network, a universal mobile telecommunications systems (UMTS) network, a code division multiple access (CDMA) network, a worldwide interoperability for microwave access (WIMAX) network, a wireless fidelity (Wi-Fi) network, and a local area network (LAN).

59. The method of claim 46 wherein the first media stream, the second media stream, and the third media stream are selected from the group consisting of: audio data, text data, image data, and video data.

60. The method of claim 46 wherein the simplex based service is a voice-over-IP (VoIP) session.
